(19) United States
(12) Patent Application Publication
(10) Pub. No.: US 2011/0140587 A1
(43) Pub. Date: Jun. 16, 2011

(54) Multi-facet light source LED lamp

(76) Inventor: Han-Ming Lee, Hsinchu City (TW)

(21) Appl. No.: 12/653,368

(22) Filed: Dec. 14, 2009

(51) Int. Cl. H01J 61/52

(52) U.S. Cl. 313/46

(57) ABSTRACT

The present invention relates to a multi-facet light source LED lamp, comprising the lamp cap, lamp base, circuit board, conductive pin and a plurality of LED conducting brackets; the main improvements including: the circuit board may be welded with more than two sets of LED conducting brackets, forming a single lamp with a plurality of light sources; furthermore, the center of the upper end of the outer LED conducting brackets is designed toward the taper angle surface, making the outer chips generating a upward taper surface coalescence center and emit light intensively to the conducting brackets; and through the staggered radiators at the bottom of the conducting brackets, the heat of the chips at the top is transferred rapidly downward to the doubled area of contact surface of radiators so that the heat is diffused rapidly.

### BACKGROUND OF THE INVENTION

The lighting principle of the traditional LED is that chips are built inside the chip cup above the bracket and power is input at the bottom of the bracket to generate light source that is refracted forward. However, when the structure is actually used for the high power chips, serious high heat is generated as a result of being used for a long time; moreover, as the chips are sealed in transparent adhesive tape, effects of accumulated high heat that can not be diffused results in prolonged operation of the chips under high temperature, which further results in premature optical decay, reducing the luminance of the light emitted and shortening the service life of the chips.

### SUMMARY OF THE INVENTION

The primary purpose of the present invention is to provide a multi-facet light source LED lamp and in particular to one in which the circuit board may be welded with 2 or more sets of corresponding LED conducting brackets so that the variant efficiencies of a plurality of LED light sources in a single lamp may be achieved.

The secondary purpose of the present invention is to provide a multi-facet light source LED lamp and in particular to one in which the center of the upper end of the LED conducting bracket is designed toward the taper angle surface, making the outer chips generating an upward taper surface coalescence center and emit light intensively to the conducting brackets.

Another purpose of the present invention is to provide a multi-facet light source LED lamp, wherein staggered radiators are designed at the bottom of the conducting brackets so that the heat of the chips at the top is transferred rapidly downward to the doubled area of contact surface of radiators and diffuse the head rapidly.

### BRIEF DESCRIPTION OF THE DRAWINGS

FIG. 1 is a 3D diagram of the present invention.

FIG. 2 is a schematic diagram of the components of the present invention.

FIG. 3 is a schematic of the outer conducting bracket of the present invention toward the central taper angle surface.

FIG. 4 is a side view of the multi-facet light function of the present invention.

FIG. 5 is a schematic of radiating efficiency of the present invention.

FIG. 6 is a diagram of comparison of the conducting bracket of the present invention with the traditional conducting bracket.

FIG. 7 is a 3D diagram of the implementation of another 4 sets of conducting brackets of the present invention.

FIG. 8 is a decomposition diagram of the components of another 4 sets of conducting brackets of the present invention.

FIG. 9 is a 3D diagram of the implementation of another 3 sets of conducting brackets of the present invention.

FIG. 10 is a decomposition diagram of the components of another 3 sets of conducting brackets of the present invention.

FIG. 11 is a 3D diagram of the implementation of another 2 sets of conducting brackets of the present invention.

FIG. 12 is a decomposition diagram of the components of another 2 sets of conducting brackets of the present invention.

### DETAILED DESCRIPTION OF THE PREFERRED EMBODIMENT

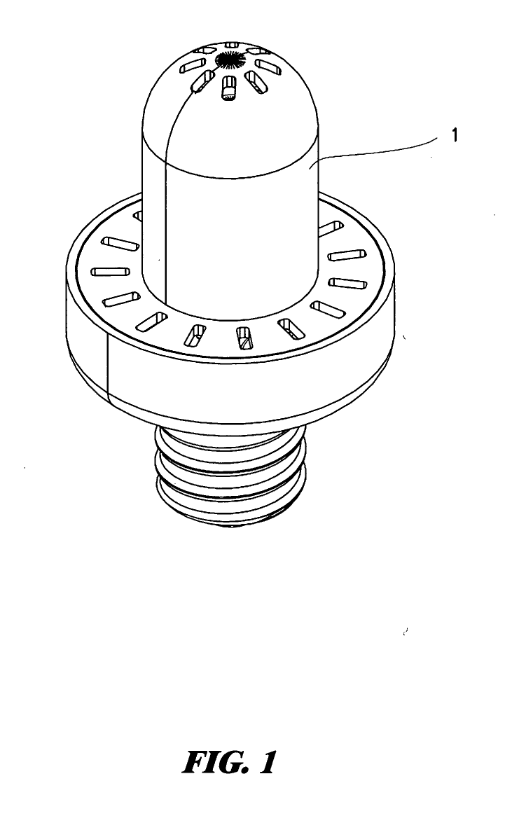

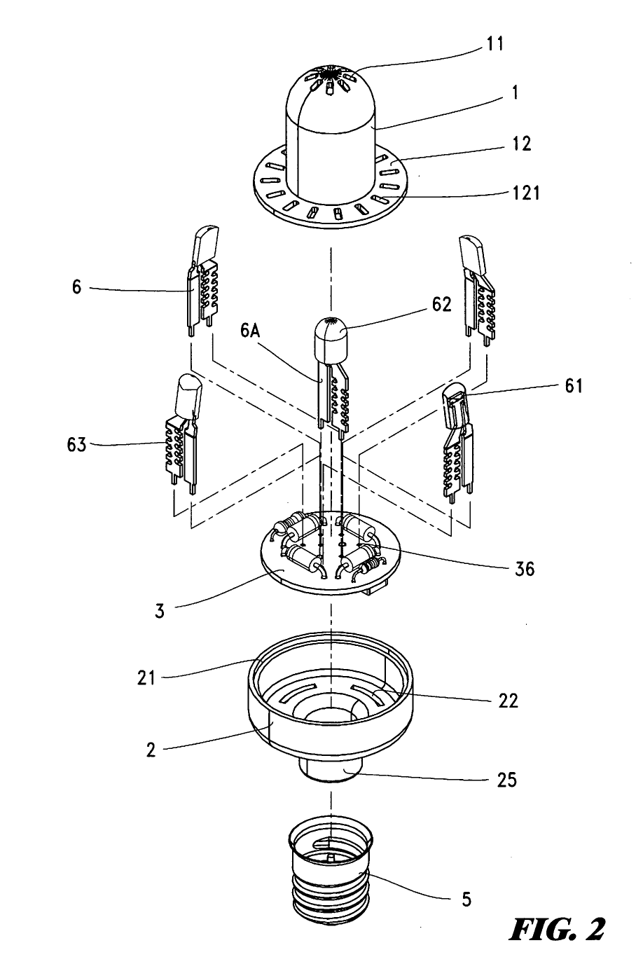

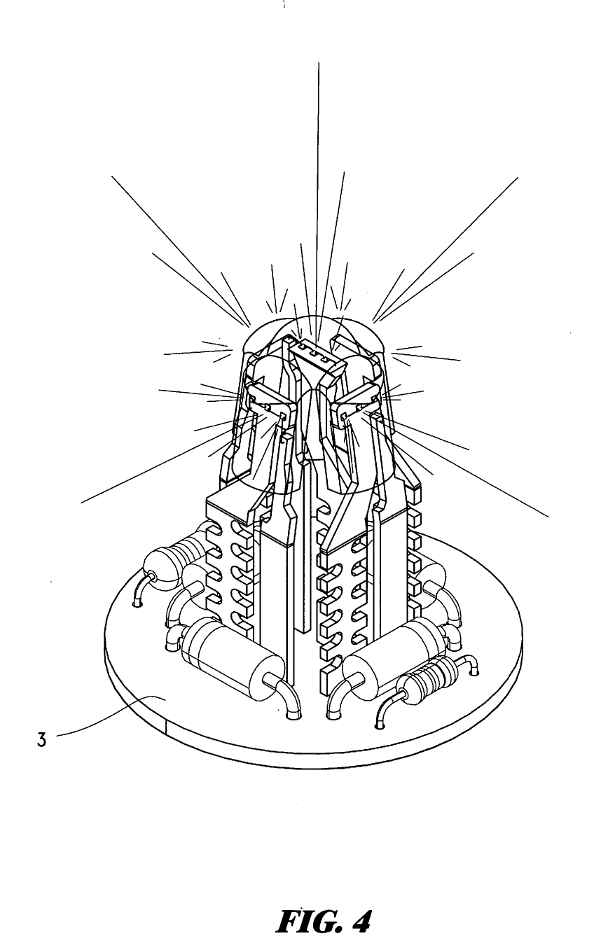

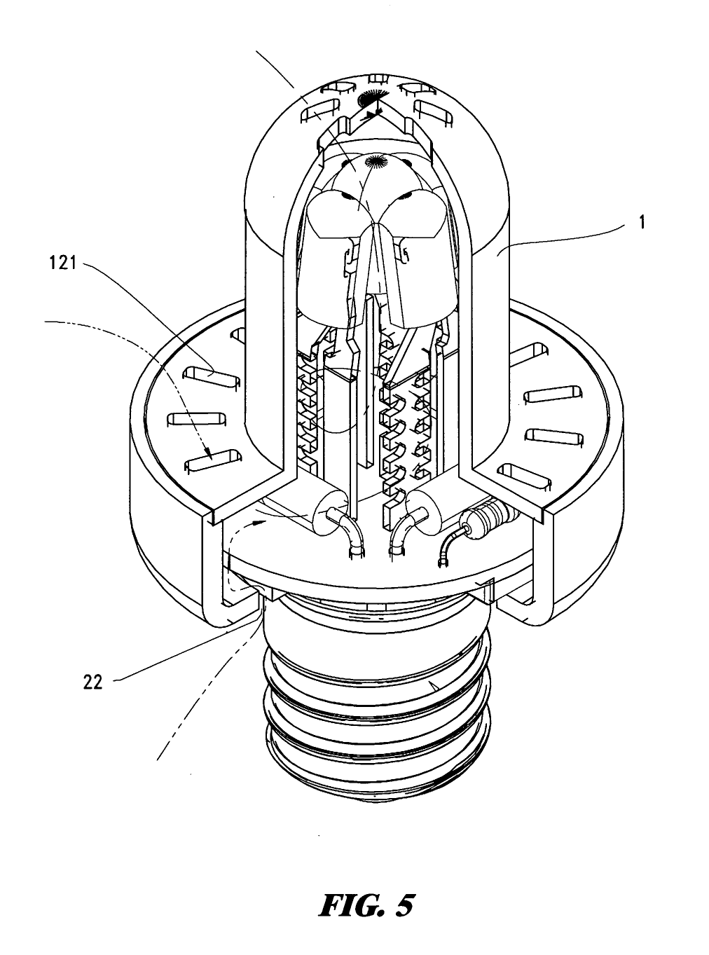

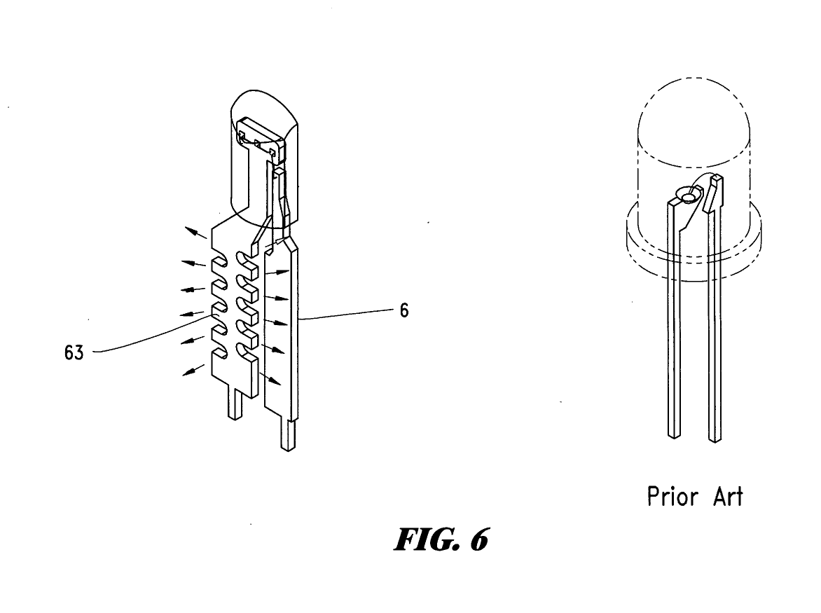

Please refer to FIG. 1 through FIG. 6. The present invention relates to a multi-facet light source LED lamp, comprising the lamp cap 1, lamp seat 2, circuit board 3, conducting pin 5 and a plurality of LED conducting brackets 6; the lamp cap 1 is an open thin cover made of light-transmitting material, the enclosed end above the cover is provided with equally spaced radiating holes 11, the cap ring 12 at the opening is also provided with equally spaced radiating holes 121; the lamp seat 2 is a lamp seat in relative to the opening of the lamp cap 1, the opening of the lamp seat is provided with outer expanded ring diameter 21 for embedding and positioning of the cap ring 12 of the lamp cap, the outer ring surface at the bottom of the lamp seat is provided with a plurality of radiating holes 22, a snap ring 25 projects downward from the center of the bottom of the lamp seat; the circuit board 3 is a LED lamp conducting control circuit for embedding into the opening of the lamp seat 2, the top of the circuit board is provided with a plurality of welding holes 36 and its bottom is provided with the input power connecting end; the conducting pin 5 is a traditional bulb screw conducting joint or conducting rod structure for screwing or inserting into the snap ring 25 at the bottom of the lamp seat to be connected with the circuit board 3; for the plurality of LED conducting brackets 6, the center of the upper end of the LED conducting brackets at the central outer ring is toward the taper angle surface, the upper end of one of the conducting brackets extends to present the trapezoidal block surface 61 for serial connection between the plurality of chips and the conducting wire; the center of the conducting brackets is toward the taper angle surface through sealing with transparent adhesive tape so that the chips generate upward taper surface lighting effect; moreover, the upper end of the central conducting bracket 6A may extend to present a trapezoidal block surface 62 for serial connection and sealing of the plurality of chips with the conducting wire; the trapezoidal block surfaces 61 and 62 are designed with left and right staggered radiators 63 at the bottom for insertion of the conducting brackets into the welding holes 36 on the circuit board.

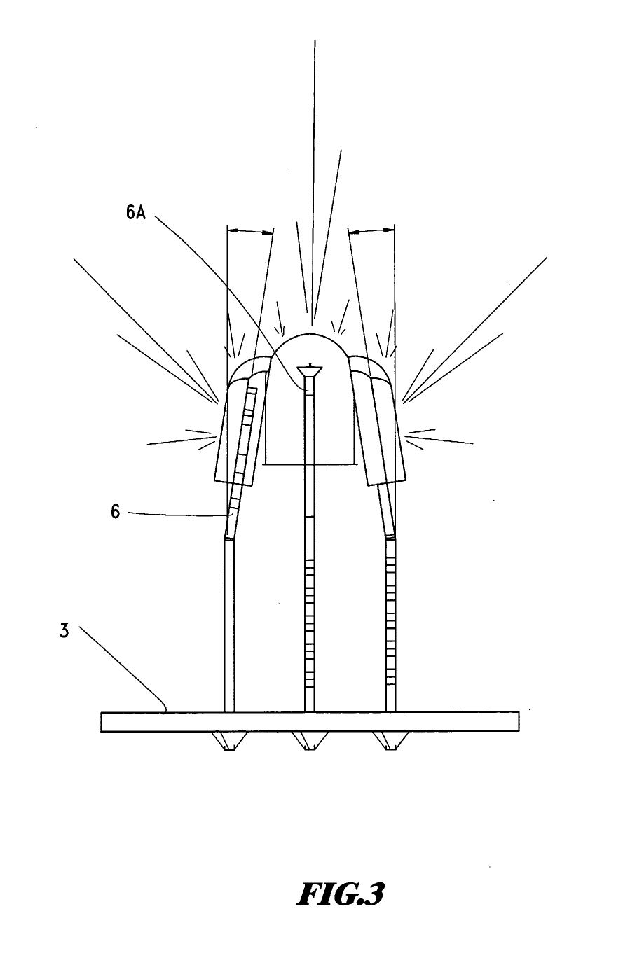

Please refer to FIG. 3 through FIG. 5 for the embodiment of the present invention. The circuit board 3 is welded with 4 sets of corresponding conducting brackets 6 on 3 sides and its center is toward the central conducting bracket 6A to achieve the efficiency of multiple LED light sources provided in a single lamp; the center of the transparent adhesive tape above the central outer ring conducting bracket 6 is toward the taper angle surface, making the outer chips generate a upward taper surface coalescence center and emit light intensively to the conducting brackets 6A; the bottom of the trapezoidal block surfaces 61 and 62 is provided with left and right staggered radiators 63 so that the heat of the chips at the top is transferred downward rapidly to the doubled area of contact surface of the radiators, enable cyclic convection and rapid diffusion of the heat through the radiating holes 11, 121 and 22 and achieve the industrial application of a single multi-facet light source LED.

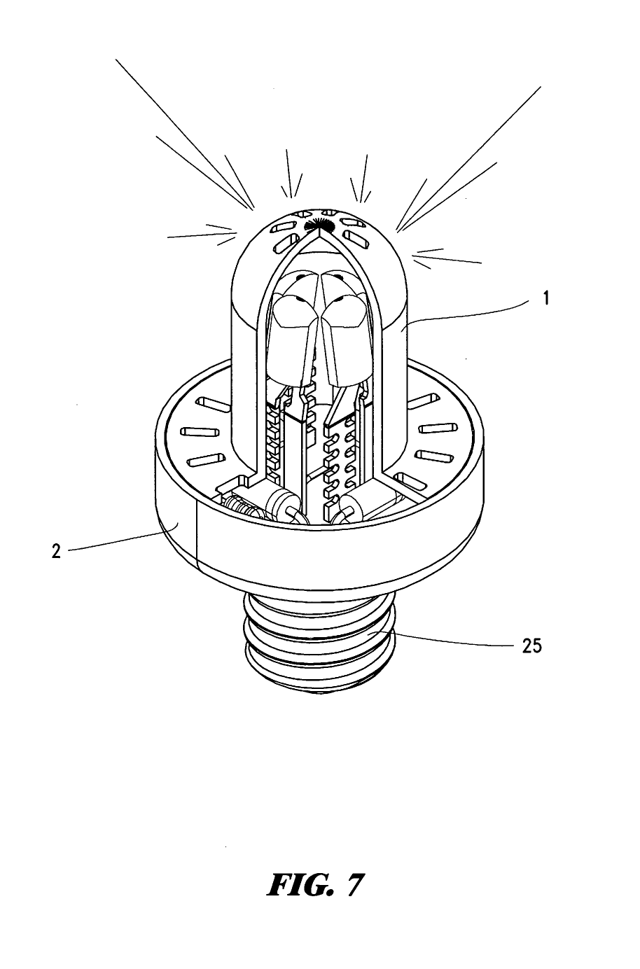

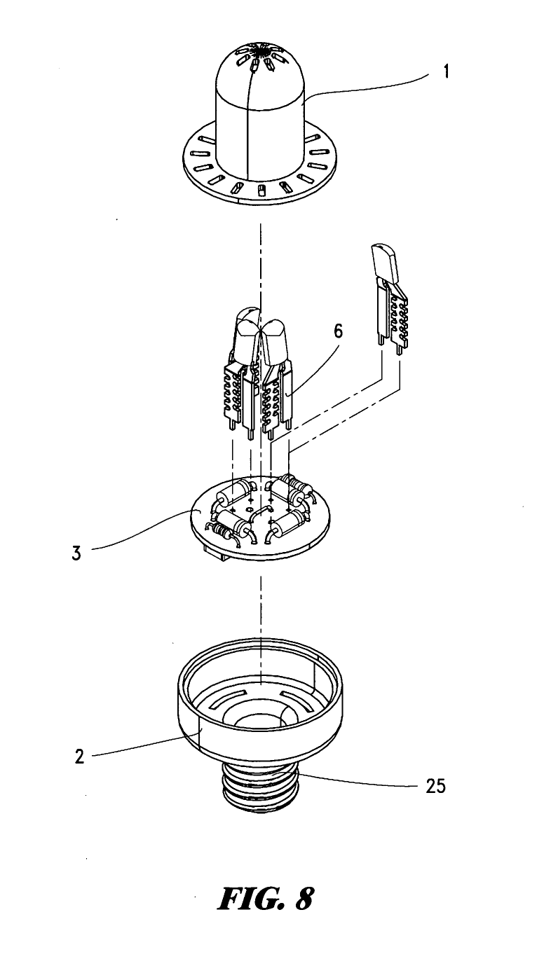

Please refer to FIG. 7 and FIG. 8 for another embodiment of the present invention. The circuit board is provided with 4 sets of corresponding conducting brackets 6 on the 3 sides so that the center of the light sources provided in a single lamp is toward the taper angle surface and the outer chips generate upward taper surface lighting effect.

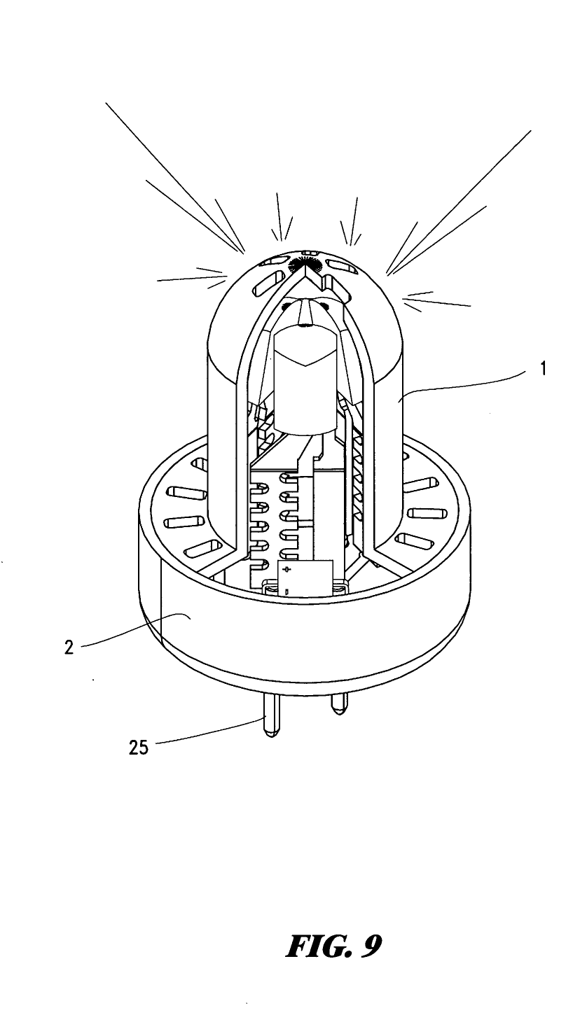

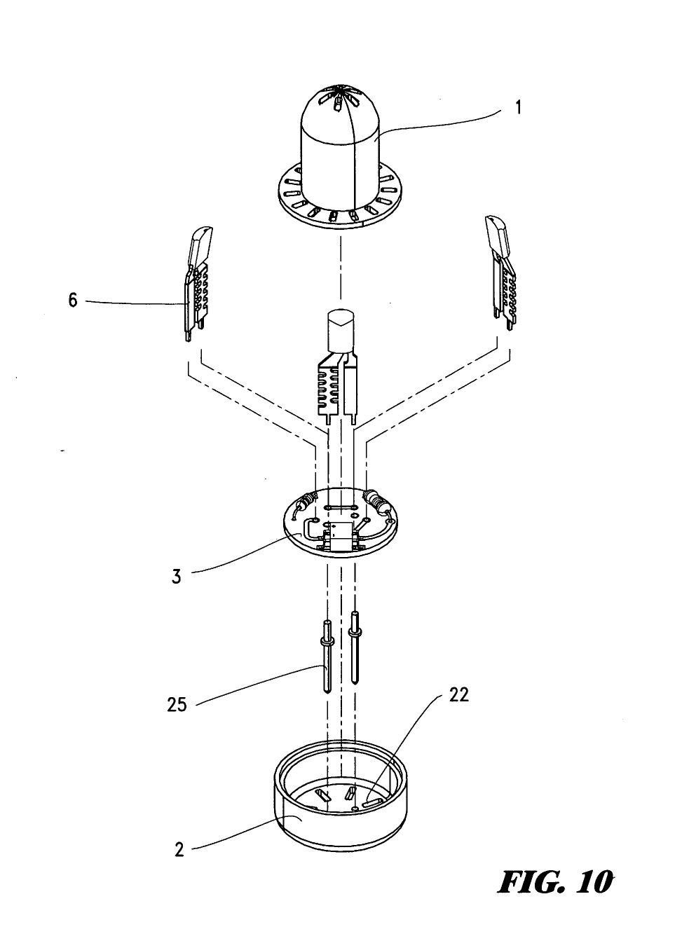

Please refer to FIG. 9 and FIG. 10 for another embodiment of the present invention. The circuit board is welded with 3 sets of corresponding conducting brackets 6 on 3 sides so that the center of the light sources in a single lamp is toward the taper angle surface and the outer chips emit light to the upper taper surface.

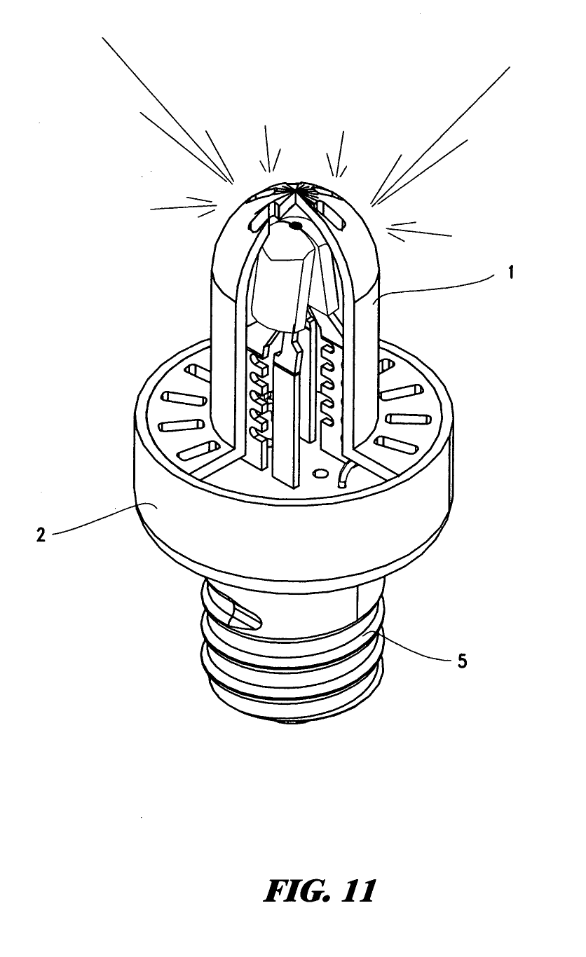

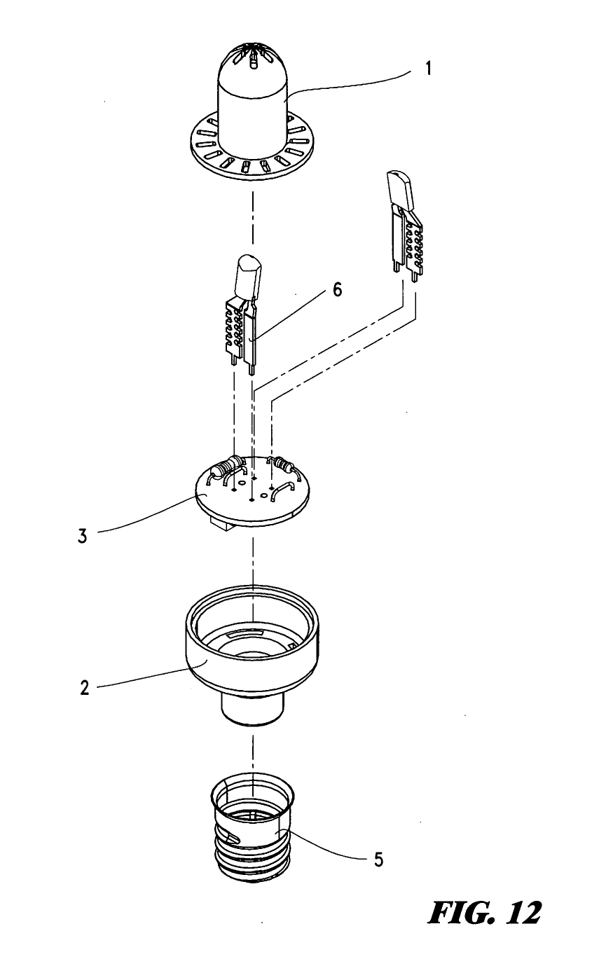

Please refer to FIG. 11 and FIG. 12 for another embodiment of the present invention. The circuit board is welded with 2 sets of corresponding conducting brackets 6 on 3 sides so that the center of the light sources in a single lamp is toward the taper angle surface and the outer chips emit light to the upper taper surface.

I claim:

1. A multi-facet light source LED lamp, comprising the lamp cap, lamp seat, circuit board, conducting pin and a plurality of LED conducting brackets, its main improvement in; the plurality of LED conducting brackets welded with the circuit board are such that the center of the upper end of the LED conducting brackets of the outer ring are designed toward the taper angle surface, the upper end of the conducting bracket extends to present the trapezoidal block surface for fastening and serial connection of the plurality of chips with the conducting wire; the center is designed toward the taper angle surface through integrated sealing with transparent adhesive tape and the center extends upward toward the upper end of the conducting brackets to present a trapezoidal block surface for fastening and serial connection of the plurality of chips with the conducting wire, making the outer chips generate an upward taper surface coalescence center and emit light intensively to the conducting brackets; and through the staggered radiators at the bottom of the conducting brackets, the heat of the chips at the top is transferred rapidly downward to the doubled area of contact surface of radiators, diffuse the heat rapidly and provide a single multi-facet light source LED.

2. The multi-facet light source LED lamp according to claim 1, wherein the plurality of LED conducting brackets may offer the efficiency of variant combinations of more than 2 sets.
